(19) United States
(12) Patent Application Publication
(10) Pub. No.: US 2002/0015862 A1
(43) Pub. Date: Feb. 7, 2002

(54) Magnetic recording medium

(75) Inventor: Yusuke Fujino, Miyagi (JP)

Correspondence Address: SONNENSCHEIN NATH & ROSENTHAL, P.O. BOX 061080, WACKER DRIVE STATION, CHICAGO, IL, 60606-1080, US

(73) Assignee: Sony Corporation

(21) Appl. No.: 09/887,802

(22) Filed: Jun. 22, 2001

(30) Foreign Application Priority Data
Jun. 22, 2000 (JP) P2000-188497

(51) Int. Cl. G11B 5/733

(52) U.S. Cl. 428/694 BS

(57) ABSTRACT

To cope with both outstanding travel durability and electromagnetic conversion characteristics. A nonmagnetic substrate, a particle dispersed layer installed on the nonmagnetic substrate and containing inert fine particles and a dispersant, and a magnetic layer installed on the particle dispersed layer are equipped.

### BACKGROUND OF THE INVENTION

1. Field of the Invention

The present invention relates to a magnetic recording medium equipped with a nonmagnetic substrate and metal magnetic thin film affixed with ferromagnetic metal particles as a magnetic layer.

2. Description of the Related Art

As a magnetic recording medium such as magnetic tapes, magnetic disks, etc., a so-called metal magnetic thin film type magnetic recording medium has been put into practical use, in which a metal magnetic thin film comprising ferromagnetic metal particles are affixed onto a nonmagnetic substrate by techniques such as vapor deposition is used for the magnetic layer, in order to meet requirements for increased high-density recording.

The metal magnetic thin-film type magnetic recording medium provides less spacing loss and possesses higher recording density as compared to so-called coated type magnetic recording medium because it not only achieves high magnetic energy but also is equipped with outstanding surface smoothness.

However, as the surface smoothness of the magnetic layer excessively advances, the magnetic layer surface becomes the condition close to a mirror surface, and the contact area with sliding members such as a magnetic head, guide rollers, etc. increases and the friction factor increases, causing a problem of easily generating an adhesion phenomenon (so-called “sticking”).

Therefore, for example, by internally adding fine particles to the nonmagnetic substrate to provide a protrusion on the nonmagnetic substrate surface, or applying a paint comprising fine particles and binder to the nonmagnetic substrate to provide a protrusion on the nonmagnetic substrate surface, suitable roughness is formed on the magnetic layer surface to reduce the real contact area between the magnetic layer surface and the magnetic head and the travel durability is secured. However, the roughness on the magnetic layer surface formed for prevention of sticking, etc. serves as a cause to generate a spacing loss, and as a result, the electromagnetic conversion characteristics were degraded.

In order to prevent degradation of electromagnetic conversion characteristics while imparting the travel durability to the metal magnetic thin-film type magnetic recording medium, it is ideal to provide protrusions of nearly same height at a suitable density for roughness provided on the magnetic layer surface. In addition, protrusions of, for example, about 5 to 15 nm are formed to improve the electromagnetic conversion characteristics but it is extremely difficult to form protrusions of this kind of small height.

For example, in Japanese Patent Publication No. Hei 1-34456, it is proposed to allow the water-soluble discontinuous polymer film and fine particles that form protrusions higher than this to independently adhere to the film surface, respectively. However, because the protrusions are discontinuous films and dispersion of fine particles are not uniform, the uniformity on the film surface was poor. In Japanese Patent Publication No. Hei 6-51401, there is proposed a substrate applied with fine particles dispersed in the discontinuous polymer film. In Japanese Non-examined Patent Publication No. Hei 8-185619, it is proposed to disperse 20-30 nm fine particles in the silica film and to reduce the apparent protrusion height by the thickness of silica film in order to cope with both fine particle dispersion and low protrusion height.

However, it is difficult to uniformly disperse fine particles with high surface energy without allowing them to condense in the film, for example, as described above, and it was unable to uniformly disperse and form protrusions. When protrusions are formed on the nonmagnetic substrate as described above and on the protrusions, the magnetic layer is installed, the surface smoothness of the magnetic layer is poor and noise is increased, causing a problem of degraded electromagnetic conversion characteristics. In addition, even when protrusions are installed on the magnetic layer as described above, spacing is generated between the magnetic recording medium and the magnetic head because dispersion of protrusions is unable to be achieved, causing a problem to degrade electromagnetic conversion characteristics.

In other words, the metal magnetic thin film type magnetic recording medium could not cope with the electromagnetic conversion characteristics and travel durability on an elevated plane.

### SUMMARY OF THE INVENTION

The present invention is proposed in view of these conventional conditions, and it is an object of the present invention to provide a magnetic recording medium that can cope with both excellent travel durability and electromagnetic conversion characteristics by installing subtle protrusions uniformly dispersed and having uniform height on the nonmagnetic substrate.

It is another object of the present invention to provide a magnetic recording medium that can cope with both excellent travel durability and electromagnetic conversion characteristics by installing subtle protrusions uniformly dispersed and having uniform height on the magnetic layer.

In order to achieve the above-mentioned objectives, the magnetic recording medium of the present invention comprises a nonmagnetic substrate and a particle dispersed layer installed on the nonmagnetic substrate and containing inert fine particles and dispersant, and a magnetic layer installed on the particle dispersed layer.

The magnetic recording medium of the present invention configured as described above has the particle dispersed layer with inert fine particles uniformly dispersed without condensing and with protrusions with uniform height equipped on the nonmagnetic substrate.

The magnetic recording medium of the present invention comprises a nonmagnetic substrate, a magnetic layer installed on the nonmagnetic substrate, a particle dispersed layer installed on the magnetic layer and containing inert fine particles and dispersant, and a protective layer installed on the particle dispersed layer.

The magnetic recording medium of the present invention configured as described above has the particle dispersed layer with inert fine particles uniformly dispersed without condensing and with protrusions with uniform height equipped on the magnetic substrate.

### BRIEF DESCRIPTION OF THE DRAWINGS

FIG. 1 is a sectional view of the essential section of a magnetic recording medium with the present invention applied; and

FIG. 2 is a sectional view of the essential section of a magnetic recording medium of another embodiment with the present invention applied.

### DETAILED DESCRIPTION OF THE PREFERRED EMBODIMENTS

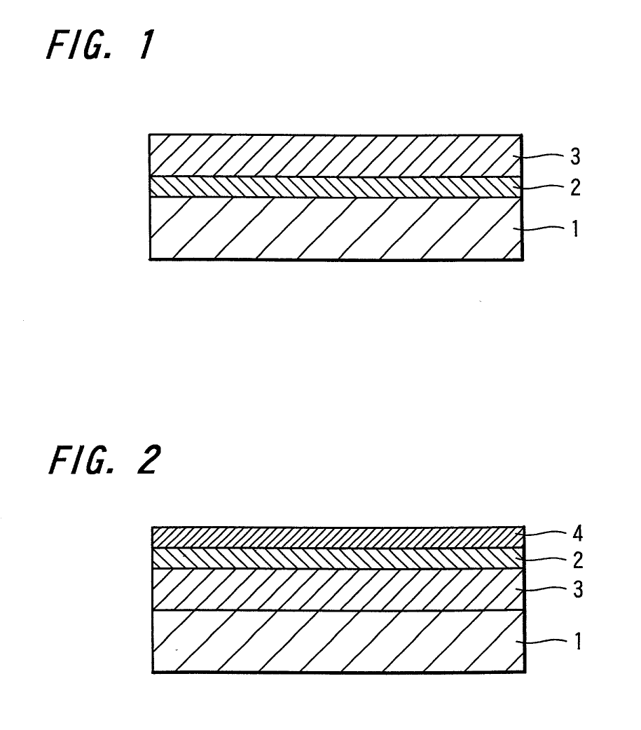

Referring now to the drawings, the magnetic recording medium with the present invention applied will be described in detail as follows. The magnetic recording medium comprises a nonmagnetic substrate 1, a particle dispersed layer 2 mounted on the nonmagnetic substrate 1 and containing inert fine particles and dispersant, and a magnetic layer 3 mounted on the particle dispersed layer 2 and affixed with ferromagnetic metal particles as shown in FIG. 1.

For the nonmagnetic substrate 1, any materials which have been conventionally used for the nonmagnetic substrate for this kind of magnetic recording medium can be used. Examples include polyesters such as polyethylene terephthalate, etc., polyorefins such as polyethylene, etc., cellulose derivatives such as cellulose triacetate, etc., vinyl-based resin such as polyvinyl chloride, etc., polymer materials such as polyimide, polycarbonate, etc., as well as light metals such as aluminum alloys, titanium alloys, etc., and ceramics such as alumina glass, etc.

The form of the nonmagnetic substrate 1 is not limited, and may be any form such as tape, sheet, etc., but when the magnetic recording medium is of a tape form, it is desirable to use polyethylene terephthalate film, polyethylene naphthalate film, aramid film (total aromatic polyamide film), etc.

In addition, to the nonmagnetic substrate 1, filler, etc. may be added internally. By this, the surface of the nonmagnetic substrate 1 roughens and the travel durability of the magnetic recording medium improves.

Furthermore, a layer for controlling the surface roughness of the nonmagnetic substrate 1 may be formed on the nonmagnetic substrate 1. In such an event, the micro-surface roughness Ra is preferably between 0.3 nm and 2.0 nm, and more suitably between 0.3 nm and 1.4 nm. Keeping the micro-surface roughness Ra to the higher range can improve the electromagnetic conversion characteristics of the magnetic recording medium.

The particle dispersed layer 2 is formed by applying a paint containing inert fine particles and a dispersant that uniformly disperses the inert fine particles to the nonmagnetic substrate 1, and is formed for providing protrusions comprising inert fine particles on the nonmagnetic substrate 1.

Examples of inert fine particles include polystyrene, poly(methyl methacrylate), methyl methacrylate copolymers, polytetrafluoroethylene, polyvinylidene fluoride, polyacrylonitrile, benzoguanamine resin, aromatic polyamide, polyimide, polysulfone, polyphenyleneoxide, etc. as organic compounds, and silica, alumina, titanium dioxide, kaolin, talc, graphite, calcium carbonate, molybdenum disulfide, carbon black, barium sulfate, etc. as inorganic compounds, but inert fine particles shall not be limited to these and optional inert materials may be used.

The inert fine particles are preferably monodispersed or uniformly dispersed in the condition close to the monodispersed condition. For the particle distribution of inert fine particles, the ratio of the particle size by weight of 75% to 25% is preferably 2.0 or less, and more suitably 1.5 or less, and most preferably 1.3 or less when it is integrated from those with smaller particle size. AS the shape of the inert fine particle, the lumpy or globular form is preferable.

When the particle dispersed layer 2 is formed on a nonmagnetic substrate 1, the mean particle size of the inert fine particle is preferably between 4 nm and 15 nm. When the mean particle size of the inert fine particle is less than 4 nm, there is a case in which the effect for imparting satisfactory travel durability to the magnetic recording medium is unable to be obtained. On the other hand, when the mean particle size of inert fine particles exceed 15 nm, excessive spacing loss may result, and the desired electromagnetic conversion characteristics may not be obtained.

When the film thickness of the magnetic layer 3 is set to “d”, the particle size of inert fine particles is preferably between 0.03 d and 0.5 d in the case of the magnetic layer 3 formed by affixing the ferromagnetic metal particles by the diagonal deposition method, and more suitably between 0.1 d and 0.2 d. In the case of the magnetic layer 3 formed by affixing a ferromagnetic metal layer by the sputtering method, the particle size of inert fine particles is preferably between 0.05 d and 1 d, and more suitably between 0.1 d and 0.5 d.

If the particle size of inert fine particles is excessively small as compared to the film thickness d of the magnetic layer 3, it is unable to improve the surface smoothness because the effects of inert fine particle effects become smaller as compared to the roughness formed by the film of the magnetic layer 3.

As the particle density of inert fine particles existing on the nonmagnetic substrate 1, if the total cross sectional area of protrusions measured by the atomic force microscope (AFM) is expressed by the protrusion occupancy ratio, which is its ratio to the total area of the nonmagnetic substrate 1 in the measuring range, the protrusion occupancy ratio is preferably 30% or less and more suitably 15% or less. In addition, the protrusion occupancy ratio is preferably 2% or more, and more suitably 4% or more. When the protrusion occupancy ratio is high, that is, when the particle density of inert fine particles is high, the C/N ratio may lower and the noise may increase, possibly degrading the electromagnetic conversion characteristics. In addition, when the protrusion occupancy ratio is low, that is, when the particle density of inert fine particles is low, actions for imparting sufficient traveling capacity to the magnetic recording medium are unable to be obtained and the desired travel durability may not be obtained.

Examples of the dispersant include anionic surfactant that are molecules or their salts, which have long chains of alkylbenzene sulfonic acid, alkyl sulfosuccinate, alkyl ether sulfate, etc. as well as sulfonic acid group and carboxylic acid group, cationic surfactant that are molecules or their salts which have long chains of alkylamine, etc. and primary through quaternary amine groups, nonionic surfactant of polyethylene glycol alkyl ether, fatty acid monoester, etc., silicone-based surfactant, silane coupling agent, or dimmer, oligomer, etc. containing sulfonic acid group, amine salt, etc.

The dispersant is properly selected in accordance with kinds of solvents, etc. contained in the inert fine particles and particle dispersant paints in order to control condensation of inert fine particles. Specifically, it is preferable to select the dispersant whose condensation degree of inert fine particles calculated from Equation 1 shown below is 1.8 or less, and more suitably, the condensation degree of inert fine particles is 1.3 or less, and most suitably, the condensation degree of inert fine particles is 1.1 or less.

### Equation 1

Condensation degree of inert fine particles=(total quantity of inert fine particles applied)/(apparent total quantity of protrusions)

When the condensation degree of inert fine particles is calculated, first of all, right after the particle dispersed layer 2 is formed, the specified range (for example, range of 3 μm×3μm) is observed at several places (for example, 5 places) using, for example, a scanning electron microscope, etc. and the number of inert fine particles is counted. The number of total inert fine particles existing in the specified range is designated as the “total quantity of inert fine particles applied”. Of the inert fine particles applied, if particles condense and exist as particle groups, each particle group is counted as one and the total quantity of particle groups and inert fine particles not condensed is designated as the“apparent total quantity of protrusions”.

The solvent of the paint containing inert fine particles and dispersant is preferably nonpolar solvent such as toluene, xylene, cyclohexane, etc.

The magnetic layer 3 is a metal magnetic thin film mounted by affixing ferromagnetic metal particles on the particle dispersed layer 2.

Examples of a magnetic thin film include metals such as Fe, Co, Ni, etc., and Co—Ni-based alloys, Co—Pt-based alloys, Co—Pt—Ni-based alloys, Fe—Co-based alloys, Fe—Ni-based alloys, Fe—Co—Ni-based alloys, Fe—Ni—B-based alloys, Fe—Co—Ni—B-based alloys, etc. for the longitudinal magnetic recording, and Co—Cr, etc. for the perpendicular magnetic recording.

The magnetic layer 3 may be a single-layer metal magnetic thin film, and may be a multi-layer metal magnetic thin film, though it is not illustrated. Furthermore, when the magnetic layer is a multi-layer metal magnetic thin film, an intermediate layer may be installed in order to improve the inter-layer adhesion between metal magnetic thin films. In addition, mounting the intermediate layer enables the control of the anti-magnetic force.

Furthermore, when the magnetic layer 3 for the longitudinal magnetic recording is formed, a substrate layer of low-melting nonmagnetic material such as Bi, Sb, Pb, Sn, Ga, In, Ge, Si, Tl, etc. is formed in advance on the particle dispersed layer 2 and from this substrate layer, metal magnetic layer may be deposited or sputtered from the vertical direction. With this contrivance, these low-melting nonmagnetic materials diffuse in the metal magnetic thin film, the orientation is canceled and the longitudinal isotropy is secured, and at the same time, anti-magnetism or magnetic-resistance is improved.

The magnetic recording medium may have a protective layer mounted on the magnetic layer 2. By mounting the protective layer, the travel durability and corrosion resistance are improved. In addition, the magnetic recording medium may also be equipped with a back-coat layer and may hold the lubricant, rust-preventive, etc. as required.

In the case of a magnetic recording medium with no protective layer, the lubricant is directly applied onto the magnetic layer 2 and in the case of a magnetic recording medium with a protective layer, the lubricant is applied onto the protective layer. For the lubricant, those used in this kind of magnetic recording medium, for example, hydrocarbon-based lubricant, fluorine-based lubricant, extreme-pressure additive, etc. may be used.

For the rust-preventive, any of those used in this kind of magnetic recording medium may be used. Specifically, examples include phenols, naphthols, quinones, heterocyclic compounds containing nitrogen atoms, heterocyclic compounds containing oxygen atoms, heterocyclic compounds containing sulfur atoms, etc.

The rust-preventive may be applied in combination with the lubricant but higher effects are obtained by separately forming layers, such as after forming the rust-preventive layer, forming the lubricant layer on it.

The magnetic recording medium configured as described above is fabricated by forming a particle dispersed layer 2 by applying a paint containing inert fine particles and dispersant onto the non-magnetic substrate 1 and forming a magnetic layer 3 by affixing ferromagnetic metal particles onto the particle-dispersed layer 2.

Examples of a method for applying the paint containing inert fine particles and dispersant for forming the particle dispersed layer 2 include a roll-coat method, gravure coat method, wire bar method, roll brush method, spray coat method, air-knife coat method, impregnation method, curtain coat method, dip coat method, spin coat method, etc., which are used alone or in combination.

When the paint is applied as described above, the inert fine particles are not fixed but held on the nonmagnetic substrate 1. Therefore, a magnetic layer 3 is formed on the particle dispersed layer 2 and inert fine particles are fixed onto the nonmagnetic substrate 1.

As the method for affixing ferromagnetic thin films for forming the magnetic layer 3, so-called PVD techniques are mentioned, such as a vacuum deposition method in which ferromagnetic thin films are deposited by heating and evaporating them in a vacuum, an ion plating method for evaporating ferromagnetic thin films in electric discharge, sputtering in which atoms on the target surface are kicked out by argon ions that caused glow discharge in the atmosphere primarily composed with argon, etc.

Because the magnetic recording medium fabricated as described above has the particle dispersed layer 2 where inert fine particles are uniformly dispersed without condensing and protrusions with uniform height are formed equipped on the nonmagnetic substrate 1, sticking, etc. can be prevented and at the same time, the satisfactory surface smoothness is achieved, and outstanding travel durability and electromagnetic conversion characteristics are successfully combined.

Now, the present invention is applied to the magnetic recording medium comprising a magnetic layer 3, particle dispersed layer 2, and protective layer 4 laminated on a nonmagnetic substrate 1 in that order as shown in FIG. 2. That is, when the magnetic recording medium is equipped with the protective layer 4, the particle dispersed layer 2 is located between the magnetic layer 3 and the protective layer 4, and protrusions can be provided on the magnetic layer 3. In this case, component elements same as those in the magnetic recording medium shown in FIG. 1 are denoted by the same reference numerals and their descriptions will be omitted.

When the particle dispersed layer 2 is formed on the magnetic layer 3 in this way, the mean particle size of inert fine particles are preferably between 4 nm and 15 nm. When the mean particle size of inert fine particles is less than 4 nm, actions for imparting satisfactory traveling capabilities to the magnetic recording medium may not be obtained. On the other hand, when the mean particle size of inert fine particles exceeds 15 nm, excessive spacing loss may be generated, and the desired electromagnetic conversion characteristics may not be obtained.

For the particle density of inert fine particles existing on the magnetic layer 3, if the total cross sectional area of protrusions measured by the atomic force microscope (AFM) is expressed by the protrusion occupancy ratio shown with its ratio to the total area of the magnetic layer in the measuring range, the protrusion occupancy ratio is preferably between 3 and 30%. When the protrusion occupancy ratio is high, that is, when the particle density of inert fine particles is high, the output may lower. In addition, because the practical contact area is large and the friction factor is increased, the traveling capability may be degraded. On the other hand, when the protrusion occupancy ratio is low, that is, when the particle density of inert fine particles is low, actions for imparting sufficient traveling capacity to the magnetic recording medium are unable to be obtained and the desired travel durability may not be obtained.

When the particle dispersed layer 2 is formed on the magnetic layer 3, the surface roughness Ra of the magnetic layer 3 is preferably between 0.5 and 2.5 nm, and more suitably between 0.5 and 1.3 nm. By keeping the surface roughness of the magnetic layer 3 in the above-mentioned range, the action of the particle dispersed layer 2 to provide the magnetic recording medium with the traveling capability can be more effectively obtained.

Examples of the material of the protective layer 4 include oxides such as silica, alumina, titania, zirconia, cobalt oxide, nickel oxide, etc., carbide such as silicon carbide, chromium carbide, boron carbide, carbon such as graphite, amorphous carbon, etc., and others. In particular, the protective layer composed of carbon is preferable because the layer is difficult to cause seizure to the head, etc. even when sliding is repetitively carried out, less wear is generated at the head, and in addition, these effects are maintained.

When the metal magnetic thin film for the longitudinal magnetic recording is formed, a substrate layer of low-melting nonmagnetic material such as Bi, Sb, Pb, Sn, Ga, In, Ge, Si, Tl, etc. is formed in advance on the nonmagnetic substrate 1, and from this substrate layer, metal magnetic particles may be deposited or sputtered in the vertical direction. With this contrivance, these low-melting nonmagnetic materials diffuse in the metal magnetic thin film, the orientation is canceled and the longitudinal isotropy is secured, and at the same time, anti-magnetism or magnetic-resistance is improved.

The magnetic recording medium may also be equipped with a back-coat layer and may hold the lubricant, rust-preventive, etc. as required. The magnetic layer 3 may be a single-layer metal magnetic thin film, and may be a multi-layer metal magnetic thin film, though it is not illustrated. Furthermore, an intermediate layer may be installed between the nonmagnetic substrate 1 and the magnetic layer 3, or when the magnetic layer is a multi-layer metal magnetic thin film, an intermediate layer may be installed in order to improve the inter-layer adhesion between metal magnetic thin films. In addition, mounting the intermediate layer enables the control of the anti-magnetic force.

The magnetic recording medium configured as described above is fabricated by forming the magnetic layer 3 by affixing ferromagnetic metal particles on the nonmagnetic substrate 1, forming the particle dispersed layer 2 on the magnetic layer 3 by applying the particle dispersed paint containing inert fine particles and dispersant, and forming the protective layer 4 by affixing, for example, carbonaceous material, etc. on the particle dispersed layer 2.

The method for affixing the ferromagnetic metal particles and the method for applying the particle dispersed paint are the same as those described above.

When the paint is applied as described above, the inert fine particles are not fixed but held on the magnetic layer 3. Therefore, a protective layer 4 is formed on the particle dispersed layer 2 and inert fine particles are fixed onto the magnetic layer 3.

Examples of the method for forming the protective layer 4 include the plasma CVD method, sputtering method, etc.

Because the magnetic recording medium fabricated as described above has the particle dispersed layer 2 where inert fine particles are uniformly dispersed without condensing and protrusions with uniform height are formed equipped on the magnetic layer 3, sticking, etc. can be prevented and at the same time, the satisfactory surface smoothness is achieved, and outstanding travel durability and electromagnetic conversion characteristics are successfully combined.

The above-mentioned magnetic recording medium is suited for a magnetic recording medium used for helical scan magnetic recording system in which the magnetoresistance effect type reproducing head is used. The magnetic layer 3 is regulated to achieve the maximum output without saturating the magnetoresistance effect type reproducing head under the condition free of distortion by controlling the kind, etc. of metal magnetic particles used. Specifically, the value of Mr·δ, the product of residual magnetizing rate Mr of the magnetic layer 3 by the film thickness δ, is made to achieve 0.8-6.5 memu/cm². The film thickness δ is preferably between 15 nm and 130 nm. By holding the film thickness δ to the above-mentioned range, the C/N ratio is improved.

Now, description will be made on specific examples of the present invention.

### Experiment 1

In Experiment 1, a magnetic tape equipped with protrusions was fabricated by allowing fine particles to be held on the nonmagnetic substrate.

### EXAMPLE 1

First of all, the particle dispersed layer was formed by applying a paint containing silica fine particles as inert fine particles and sodium dodecylbenzensulfonate as a dispersant on an aramid film (thickness: 4 μm; surface roughness Ra: 0.7 nm) as a nonmagnetic substrate at an application rate of 4.5 ML/m² by a gravure roll. The composition of the paint containing the inert fine particles and the dispersant is shown as follows.

Composition of the paint forming the particle dispersed layer

| | | |
|---|---|---|
| Inert fine particles: silica (mean particle size: | 0.005 | parts by weight |
| 7 nm) | | |
| Dispersant: sodium dodecylbenzensulfonate | 0.03 | parts by weight |
| Solvent: toluene | 100 | parts by weight |

Then, on the particle dispersed layer, Co was affixed by the vacuum deposition method and a metal magnetic thin film 40 nm in film thickness was formed as a magnetic layer. The film forming conditions of the metal magnetic thin film are shown as follows:

Film forming conditions

| | |
|---|---|
| Incidence angle of deposited particles: | 45-90° |
| Oxygen introducing rate: | 450 sccm |
| Vacuum at the time of deposition: | 7 × 10⁻² Pa |

The coercive force Hc of the metal magnetic thin film was adjusted to 110 kA/m and the residual magnetic flux density Br to 0.45 T by partially oxidizing the Co metal magnetic thin film by introducing oxygen.

And carbon is affixed to the magnetic layer by the sputtering method and a protective layer composed of carbon with 6 nm film thickness was formed. The film forming conditions of the protective layer are shown as follows:

Film forming conditions

| | |
|---|---|
| Back pressure: | 4 × 10⁻³ Pa |
| Ar pressure: | 4 × 10⁻¹ Pa |
| Sputtering power: | 6 kW |

Further, each of the back coat composition was charged in a ball mill in conformity to the following composition, dispersion was carried out for 24 hours to mix, and then, a bridging agent was added to adjust the back coat paint. On the other main surface opposite to one main surface on which the metal magnetic thin film was formed for the nonmagnetic substrate, the back coat paint was applied and a back coat layer 0.6 μm thick was formed.

Composition of the back coat layer

| | | |
|---|---|---|
| Carbon black: silica (mean particle size: 20 nm) | 50 | parts by weight |
| Polyester polyurethane resin: | 50 | parts by weight |
| (Polar group SO₃Na 0.1 mmol/g) | | |
| Solvent: methyl ethyl ketone | 250 | parts by weight |
| Toluene | 150 | parts by weight |
| Anone | 100 | parts by weight |

Furthermore, on the protective layer, perfluoropolyether was applied as a lubricant to form a lubricating layer; then, the sheet was cut to fabricate the magnetic tape 8 mm wide.

### EXAMPLE 2

Except forming the particle dispersed layer with the paint containing 0.01 parts inert fine particle by weight, the magnetic tape was fabricated in the same manner as in Example 1.

### EXAMPLE 3

Except forming the particle dispersed layer with the paint containing 0.02 parts inert fine particle by weight, the magnetic tape was fabricated in the same manner as in Example 1.

### EXAMPLE 4

Except forming the particle dispersed layer with the paint containing silica of 4 nm mean particle size and whose content was 0.003 parts by weight used as inert fine particles, the magnetic tape was fabricated in the same manner as in Example 1.

### EXAMPLE 5

Except forming the particle dispersed layer with the paint containing silica of 4 nm mean particle size and whose content was 0.01 parts by weight used as inert fine particles, the magnetic tape was fabricated in the same manner as in Example 1.

### EXAMPLE 6

Except forming the particle dispersed layer with the paint containing stearyl amide used as a dispersant, the magnetic tape was fabricated in the same manner as in Example 1.

### EXAMPLE 7

Except forming the particle dispersed layer with the paint containing silane coupling gent (A-1310 available from Nihon Uniker) used as a dispersant, the magnetic tape was fabricated in the same manner as in Example 1.

### EXAMPLE 8

Except forming the particle dispersed layer with the paint containing 0.01 parts inert fine particle by weight and using polyethylene naphthalate film for the nonmagnetic substrate, the magnetic tape was fabricated in the same manner as in Example 1.

### Comparative Example 1

For the nonmagnetic substrate, a paint containing silica fine particles as inert fine particles and modified polyacrylic acid (SHJ2007 available from Nippon Zeon) as a binder was applied onto the aramid film (thickness: 4 μm; surface roughness Ra: 0.7 nm) at an application rate of 4.5 mL/m² by a gravure roll. The composition of the paint containing the inert fine particles and the binder is shown as follows:

Composition of the paint forming the particle dispersed layer

| | | |
|---|---|---|
| Inert fine particles: silica (mean particle size: | 0.01 | parts by weight |
| 12 nm) | | |
| Binder: modified polyacrylic acid | 0.03 | parts by weight |
| Solvent: isopropyl alcohol | 100 | parts by weight |

Then, on the layer containing the inert fine particles and the binder, a magnetic layer was formed, and on the magnetic layer, a protective layer was formed, and on the other main surface of the nonmagnetic substrate, a back coat layer was formed in the similar manner as in Example 1. Furthermore, on the protective layer, perfuloropolyether was applied as a lubricant to form a lubricating layer, and then, the sheet was cut to fabricate a magnetic tape 8 mm wide.

### COMPARATIVE EXAMPLE 3

Except using a paint containing silica 7 nm of mean particle size and whose content was 0.005 parts by weight as inert fine particles, the magnetic tape was fabricated in the same manner as in Comparative Example 1.

### COMPARATIVE EXAMPLE 3

Except using a paint containing silica 7 nm of mean particle size and whose content was 0.02 parts by weight as inert fine particles, the magnetic tape was fabricated in the same manner as in Comparative Example 1.

### COMPARATIVE EXAMPLE 4

Except using a paint containing silica 7 nm of mean particle size and whose content was 0.005 parts by weight as inert fine particles and using polyethylene naphthalate film for the nonmagnetic substrate, the magnetic tape was fabricated in the same manner as in Comparative Example 1.

With respect to the magnetic tapes of Examples 1 through 8 and Comparative Examples 1 through 4 prepared as described above, following evaluations were carried out.

(1) Fine particle dispersion degree

After forming the particle dispersed layer, using a scanning electron microscope (SE-900 available from Hitachi, Ltd.), photomicrographs were taken at 5 places in the range of 3 μm×3 μm in the particle dispersed layer. And the condensation rate of fine particles in the range was found by Equation 1 described above and the fine particle dispersion degree was evaluated.

(2) Surface roughness

By obtaining tapping mode AFM images using an atomic force microscope (Nanoscope3 available from Digital Instrument), the Ra value and Rz value were measured and the surface roughness of the magnetic layer was evaluated. The measured area was set to 10×10 μm.

(3) Electromagnetic conversion characteristics

The electromagnetic conversion characteristics were evaluated by measuring the output at 24 MHz frequency at the relative tape speed of 6.8 m/s using a drum tester (head gap length: 0.18 μm) and finding the relative value when the reproduction output in Comparative Example 1 was set to 0 dB. In addition, electromagnetic conversion characteristics were evaluated by measuring the noises in the frequency range from 1 to 26 MHz and calculating the C/N.

(4) Friction factor

The tension T required to move the magnetic tape at 2 cm/s was measured when the magnetic tape was wrapped around a pin 90° and a 10-g load was applied. And the friction factor was evaluated by calculating the dynamic friction factor μk by Equation 2 shown below. The friction factor was measured with a stainless pin (SUS303, S value: 0.2, 2.4 mmΦ) used for the pin under the environment at 20° C. and 40% (RH).

### Equation 2

μk=2/Σ×ln(T/10)

(5) Travel durability

The travel durability was evaluated by allowing the magnetic tape (tape length: 1 m) to repetitively travel using a recording/reproducing apparatus obtained by modifying an AIT deck (available from Sony) and measuring the number of travels until the output was degraded by 6 dB. The number of cycles was set to 500 cycles as a maximum.

Table 1 shows the above measurement results. Table 1 also shows the particle size and the number of applications of inert fine particles contained in the particle dispersed layer of each magnetic tape. If the repetitive travels exceeding 500 cycles were available when the magnetic tape was allowed to travel for evaluating the travel durability, >500 (cycles) was entered.

TABLE 1

| | | Number | | | | | | | |
|---|---|---|---|---|---|---|---|---|---|
| | Mean | of appli- | | Surface | | | C/N | Dynamic | Travel |
| | particle | cations | Degree of | roughness | (nm) | Output | ratio | friction | durability |
| | size (nm) | (×10⁷/mm²) | condensation | Ra | Rz | (dB) | (dB) | factor | (cycles) |
| Example 1 | 7 | 3.0 | 1.2 | 1.3 | 32 | 1.7 | 2.8 | 0.43 | >500 |
| Example 2 | 7 | 6.0 | 1.2 | 1.5 | 34 | 1.4 | 2.2 | 0.41 | >500 |
| Example 3 | 7 | 9.0 | 1.3 | 1.7 | 38 | 1.2 | 1.8 | 0.40 | >500 |
| Example 4 | 4 | 4.7 | 1.8 | 1.5 | 35 | 2.1 | 3.0 | 0.51 | >500 |
| Example 5 | 4 | 15.8 | 2.0 | 1.8 | 35 | 1.9 | 2.2 | 0.48 | >500 |
| Example 6 | 7 | 6.0 | 1.3 | 1.6 | 35 | 1.4 | 2.0 | 0.40 | >500 |
| Example 7 | 7 | 6.0 | 1.2 | 1.5 | 36 | 1.4 | 2.2 | 0.42 | >500 |
| Example 8 | 7 | 3.0 | 1.2 | 1.3 | 32 | 1.4 | 3.0 | 0.42 | >500 |
| Comparative | 12 | 1.3 | 1.2 | 2.0 | 40 | 0 | 0 | 0.35 | >500 |
| Example 1 | | | | | | | | | |
| Comparative | 7 | 3.0 | 2.4 | 2.2 | 42 | 0.2 | −0.4 | 0.40 | 320 |
| Example 2 | | | | | | | | | |
| Comparative | 7 | 9.0 | 3.7 | 2.2 | 47 | −0.5 | −1.0 | 0.35 | >500 |
| Example 3 | | | | | | | | | |
| Comparative | 7 | 3.0 | 2.4 | 2.2 | 42 | 0 | 0 | 0.38 | 350 |
| Example 4 | | | | | | | | | |

As clear from Table 1, it has been indicated that the magnetic tapes of Examples 1 through 8 have the magnetic layer surface appropriately smoothed and provided low noise and excellent electromagnetic conversion characteristics because subtle protrusions uniformly dispersed and having a uniform height are equipped on the nonmagnetic substrate and the magnetic layer is installed on these protrusions. In addition, it has also been indicated that because subtle protrusions uniformly dispersed and having a uniform height are equipped on the nonmagnetic substrate, the magnetic tape is free of sticking, etc. and achieves excellent travel durability.

On the other hand, in Comparative Examples 1 through 4 in which the paint containing inert fine particles and the binder is applied and protrusions are equipped on the nonmagnetic substrate, the dispersion of protrusions equipped on the nonmagnetic substrate becomes nonuniform and the surface properties of the magnetic layer are not good because the inert fine particles are not condensed in the binder and are difficult to be dispersed uniformly. Consequently, it has been indicated that the noise is increased and the electromagnetic conversion characteristics are degraded. In addition, it has also been indicated that when the number of applications of inert fine particles is less, even applying the paint containing inert fine particles and the binder cannot form the desired protrusions and cannot impart satisfactory travel durability.

Consequently, it has been found that the magnetic tape copes with both outstanding travel durability and electromagnetic conversion characteristics by equipping the particle dispersed layer containing inert fine particles and a dispersant on the nonmagnetic substrate and equipping the magnetic layer on this particle dispersed layer.

### EXPERIMENT 2

In Experiment 2, a magnetic tape equipped with protrusions was fabricated by allowing fine particles to be held on the magnetic layer.

### EXAMPLE 9

First of all, Co was affixed on an aramid film (thickness: 4 μm; surface roughness Ra: 0.7 nm) as a nonmagnetic substrate by vacuum deposition method, on which a metal magnetic thin film 40 nm in film thickness was formed as a magnetic layer. The film forming conditions of metal magnetic thin film were same as in Example 1.

Then, on the magnetic layer, the particle dispersed layer was formed by applying a paint containing silica fine particles as inert fine particles and sodium dodecylbenzensulfonate as a dispersant at an application rate of 4.5 mL/m² by a gravure roll. The composition of the paint containing the inert fine particles and the dispersant is shown as follows.

Composition of the paint forming the particle dispersed layer

| | | |
|---|---|---|
| Inert fine particles: silica (mean particle size: | 0.003 | parts by weight |
| 4 nm) | | |
| Dispersant: sodium dodecylbenzensulfonate | 0.03 | parts by weight |
| Solvent: toluene | 100 | parts by weight |

And carbon was affixed to the particle dispersed layer by the sputtering method and a protective layer composed of carbon with 6 nm film thickness was formed. The film forming conditions of the protective layer were the same as those in Example 1.

Further, same as in Example 1, a back coat layer 0.6 μm thick was formed on the other main surface opposite to one main surface on which the metal magnetic thin film was formed for the nonmagnetic substrate. Furthermore, on the protective layer, perfluoropolyether was applied as a lubricant to form a lubricating layer; then, the sheet was cut to fabricate the magnetic tape 8 mm wide.

### EXAMPLE 10

Except forming the particle dispersed layer with the paint containing 0.01 parts inert fine particle by weight, the magnetic tape was fabricated in the same manner as in Example 9.

### EXAMPLE 11

Except forming the particle dispersed layer with a paint containing silica of 7 nm mean particle size and whose content was 0.005 parts by weight used as inert fine particles, the magnetic tape was fabricated in the same manner as in Example 9.

### EXAMPLE 12

Except forming the particle dispersed layer with a paint containing silica of 7 nm mean particle size and whose content was 0.005 parts by weight used as inert fine particles and with the paint containing stearyl amide used as a dispersant, the magnetic tape was fabricated in the same manner as in Example 9.

### EXAMPLE 13

Except forming the particle dispersed layer with a paint containing silica of 12 nm mean particle size and whose content was 0.005 parts by weight used as inert fine particles and with the paint containing stearyl amide used as a dispersant, the magnetic tape was fabricated in the same manner as in Example 9.

### COMPARATIVE EXAMPLE 5

First of all, for the nonmagnetic substrate, Co was deposited on the aramid film (thickness: 4 μm; surface roughness Ra: 0.7 nm) by the vacuum deposition method to form a metal magnetic thin film 40 nm in film thickness. The film forming conditions of the metal magnetic thin film were same as those in Example 1.

Then, on the magnetic layer, a paint containing silica fine particles as inert fine particles and modified polyacrylic acid (SHJ2007 available from Nippon Zeon) as a binder was applied at an application rate of 4.5 ML/m² by a gravure roll. The composition of the paint containing the inert fine particles and the binder is shown as follows:

Composition of the paint forming the particle dispersed layer

| | | |
|---|---|---|
| Inert fine particles: silica (mean particle size: | 0.01 | parts by weight |
| 12 nm) | | |
| Binder: modified polyacrylic acid | 0.03 | parts by weight |
| Solvent: isopropyl alcohol | 100 | parts by weight |

Then, on the layer containing the inert fine particles and the binder, a protective layer was formed, and on the other main surface of the nonmagnetic substrate, a back coat layer was formed in the same manner as in Example 1. Furthermore, on the protective layer, perfuloropolyether was applied as a lubricant to form a lubricating layer, and then, the sheet was cut to fabricate a magnetic tape 8 mm wide.

### COMPARATIVE EXAMPLE 6

Except using a paint containing silica 7 nm in mean particle size and whose content was 0.02 parts by weight as inert fine particles, the magnetic tape was fabricated in the same manner as in Comparative Example 5.

The above-mentioned characteristics were evaluated in the same manner on the magnetic tapes of Examples 9 through 13 and Comparative Examples 5 and 6 prepared as described above. The above measurement results and the particle size and the number of applications of inert fine particles contained in the particle dispersed layer of each magnetic tape are shown in Table 2.

TABLE 2

| | | Number | | | | | | | |
|---|---|---|---|---|---|---|---|---|---|
| | Mean | of appli- | | Surface | | | C/N | Dynamic | Travel |
| | particle | cations | Degree of | roughness | (nm) | Output | ratio | friction | durability |
| | size (nm) | (×10⁷/mm²) | condensation | Ra | Rz | (dB) | (dB) | factor | (cycles) |
| Example 9 | 4 | 4.7 | 1.7 | 1.3 | 30 | 3.1 | 3.3 | 0.54 | >500 |
| Example 10 | 4 | 15.6 | 2.0 | 1.4 | 35 | 2.7 | 3 | 0.5 | >500 |
| Example 11 | 7 | 3.0 | 1.4 | 1.3 | 30 | 2.9 | 3.5 | 0.48 | >500 |
| Example 12 | 7 | 9.0 | 1.4 | 1.3 | 33 | 2.7 | 3.3 | 0.46 | >500 |
| Example 13 | 12 | 1.3 | 1.2 | 1.5 | 38 | 1 | 2.8 | 0.43 | >500 |
| Comparative | 12 | 1.3 | 1.2 | 1.5 | 40 | 0.8 | 1.4 | 0.43 | >500 |
| Example 5 | | | | | | | | | |
| Comparative | 7 | 9.0 | 3.5 | 1.5 | 43 | 0.6 | 1.2 | 0.42 | >500 |
| Example 6 | | | | | | | | | |

As clear from Table 2, it has been indicated that the magnetic tapes of Examples 9 through 13 has the magnetic layer surface appropriately smoothed and provided low noise and excellent electromagnetic conversion characteristics because subtle protrusions uniformly dispersed and having a uniform height are equipped on the magnetic layer and the protective layer is installed on these protrusions. In addition, it has also been indicated that because subtle protrusions uniformly dispersed and having a uniform height are equipped on the magnetic layer and the protective layer is installed on these protrusions, the magnetic tape is free of sticking, etc. and achieved excellent travel durability.

On the other hand, in Comparative Examples 5 and 6 in which the paint containing inert fine particles and the binder is applied to form protrusions on the magnetic layer, the dispersion of protrusions equipped on the nonmagnetic substrate becomes nonuniform, spacing loss is generated, the noise is increased, and the electromagnetic conversion characteristics are degraded because the inert fine particles are not condensed in the binder and are difficult to be dispersed uniformly.

Consequently, it has been found that the magnetic tape copes with both outstanding travel durability and electromagnetic conversion characteristics by equipping the particle dispersed layer containing inert fine particles and a dispersant on the magnetic layer and equipping the protective layer on this particle dispersed layer.

As clear from the above-mentioned description, in the present invention, because a nonmagnetic substrate, a particle dispersed layer installed on the nonmagnetic substrate and containing inert fine particles and dispersant, and a magnetic layer installed on the particle dispersed layer are equipped, protrusions uniformly dispersed and with uniform height are formed on a nonmagnetic substrate.

Consequently, according to the present invention, it is possible to obtain a magnetic recording medium that can cope with both outstanding travel durability and electromagnetic conversion characteristics.

Furthermore, in the present invention, because a nonmagnetic substrate, a magnetic layer installed on the nonmagnetic substrate, a particle dispersed layer installed on the magnetic layer and containing inert fine particles and dispersant, and a protective layer installed on the particle dispersed layer are equipped, protrusions uniformly dispersed and with uniform height are formed on a nonmagnetic substrate.

Consequently, according to the present invention, it is possible to obtain a magnetic recording medium that can cope with both outstanding travel durability and electromagnetic conversion characteristics.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A magnetic recording medium comprising
a nonmagnetic substrate,
a particle dispersed layer installed on the nonmagnetic substrate and containing inert fine particles and dispersant, and
a magnetic layer installed on the particle dispersed layer.

2. The magnetic recording medium according to claim 1, wherein the size of the inert fine particles is between 4 nm and 7 nm.

3. The magnetic recording medium according to claims 1 and 2, wherein the added amount of the inert fine particles is between 0.003 parts by weight and 0.02 parts by weight.

4. The magnetic recording medium according to claim 3, wherein the inert fine particles are silica fine particles.

5. The magnetic recording medium according to claim 4, wherein the dispersant is sodium dodecyl benzensulfonate or stearyl amide or silane coupling agent.

6. A magnetic recording medium comprising
a nonmagnetic substrate,
a magnetic layer installed on the nonmagnetic substrate,
a particle dispersed layer installed on the magnetic layer and containing inert fine particles, and
a protective layer installed on the particle dispersed layer.

7. A magnetic recording medium according to claim 6, wherein a particle dispersed layer contains dispersant.

8. The magnetic recording medium according to claim 7, wherein the size of the inert fine particles is between 4 nm and 12 nm.

9. The magnetic recording medium according to claim 8, wherein the added amount of the inert fine particles is between 0.003 parts by weight and 0.01 parts by weight.

10. The magnetic recording medium according to claim 9, wherein the dispersant is sodium dodecyl benzensulfonate or stearyl amide.

11. The magnetic recording medium according to claim 10, wherein the inert fine particles are silica fin e particles.
